(19) United States
(12) Patent Application Publication
(10) Pub. No.: US 2017/0097114 A1
(43) Pub. Date: Apr. 6, 2017

(54) Self-Supported Hose Delivery Assembly

(71) Applicants: Daniel D'Ambrosio, Medford, MA (US); Timothy Crawford Davidson, Landrum, SC (US)

(72) Inventors: Daniel D'Ambrosio, Medford, MA (US); Timothy Crawford Davidson, Landrum, SC (US)

(21) Appl. No.: 15/285,953

(22) Filed: Oct. 5, 2016

Related U.S. Application Data
(60) Provisional application No. 62/237,749, filed on Oct. 6, 2015.

(51) Int. Cl. F16L 27/04

(52) U.S. Cl. CPC F16L 27/04

(57) ABSTRACT

A self-supported hose delivery assembly includes a series of expandable socket joints attached to one another, a nozzle, and a back pressure protection apparatus. The series of attached expandable socket joints have a proximal and distal end and the nozzle is connected to the proximal and the back pressure protection apparatus is connected to the distal end. When the back pressure protection apparatus is attached to a pressure source, the substance released from the pressure source travels through the back pressure protection apparatus, through the series of expandable socket joints, to the nozzle. The expandable socket joints react to pressure and when force is applied to them, they are pulled tightly, resulting in the overall assembly stiffening up into whatever position the user wishes and be self-supporting.

### CROSS REFERENCE TO RELATED APPLICATION

This application takes the benefit of and claims priority to U.S. Provisional Patent Application Ser. No. 62/237,749 filed on Oct. 6, 2015, the contents of which are herein incorporated by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### FIELD OF INVENTION

The invention relates to a hose assembly, preferably a shape retention hose assembly permitting the hose to be self-standing and self-supporting.

### BACKGROUND OF THE INVENTION

Generally, hoses are used in a multitude of home and industrial applications. Over the years, many improvements have been made to hoses including improvements to the hose wall structure, hose flexibility, reduction of kinks, expandability, retractablity, and the like. There have also been numerous add-on components to enhance the use of these hoses including hose spray nozzles, sprinkler heads, timers, etc.

One of the difficulties of using hoses, whether in the garden, to wash a car, or other industrial uses, is the fact that the user may need to set the hose down on the ground during use. This usually requires the need for bending over to pick up the hose. A number of water hose supports and stands are known. Each of these known supports is directed towards a means for temporarily maintaining a garden hose or any other type of hose-like device in an operative position for watering gardens, delivering air, or transporting liquids, aqueous, and gasses.

The first recorded attempt to remove the need to bend over to pick up a hose was limited to a fixed hose stand that could be installed into a permanent setting. Other stands required the user to carry the stand around and then place the stand on level ground, creating a moveable hose stand. While this type of stand offers the ability to rest the hose on something, and potentially removes the need for bending over, it requires the user to either carry around a separate structure or move to where the fixed structure resides.

The need to have to carry a separate structure or walk to where a permanent stand resides creates an unnecessary burden on the user who would like to be able to place down the hose wherever he is working, without the hassle of carrying a separate structure, and then resume their work without bending over to pick it up.

Newer developments attempting to address this problem allowed hoses to be molded into different shapes that the hose would retain. This solution allowed users to bend the hose around other fixed items, removing the need for a user to bend over and pick it up. This solution was an improvement because it now allowed users to use a self-supporting hose in any location. However, because the hose had to be forcefully manipulated into shape, and it did not become limp when the water pressure was released, it would make the hose very difficult to work with and potentially extra heavy as well.

### SUMMARY OF THE INVENTION

The instant apparatus and system, as illustrated herein, is clearly not anticipated, rendered obvious, or even present in any of the prior art mechanisms, either alone or in any combination thereof. The versatile system, method and series of apparatuses for creating and utilizing a self-supported fluid delivery mechanism are illustrated. Thus the several embodiments of the instant apparatus are illustrated herein.

It is a primary object of the present multifunctional apparatus to introduce an integrated hose support assembly which allows for any type of hose whether garden hose or water vapor hose or gas hose or the like to retain a shape in order to stand up right, eliminating the need for a user to place the hose on the ground or carry or install separate hose stands. When the hose assembly is connected to a pressure source like a water spigot, or air/gas source, and the internal pressure within the hose allows a hose to stand upright and be self-supporting. When the pressure source is released, the hose loses its shape and becomes limp and flexible to be stored as a normal hose.

The integrated hose assembly is made up of a series of attached expandable socket joints, a nozzle, a flexible tube, a check valve, and a back pressure protection apparatus. The back pressure protection apparatus is attached to the distal end of the flexible tube and the nozzle is connected to the proximal end of the tube. The expandable socket joints are assembled into a series around the flexible tube. The check valve is located at a point along the series of attached expandable socket joints in order to allow a user to turn off the pressure but allow the hose to remain in its standup position until the liquid, air or gas is completely drained from the hose. The expandable socket joints expand and contract with pressure, where a pressure source is connected to the distal end of the flexible hose.

Some examples of pressure sources include a water spigot, gas tank, vapor tank or other pressure sources known in the art. Furthermore, the pressure source may be selected from the group consisting of fluid pressure, liquid pressure, gas pressure, air pressure, and vapor pressure.

For support purposes, the series of expandable socket joints run from a distal end to a proximal end of the flexible tube. The system may include only one expandable socket joint, or up to 1,000 expandable socket joints.

The expandable socket joints may include, but are not limited to, a material selected from the group consisting of plastic, stainless steel, polymer, copper, aluminum, bronze, and Teflon®. The expandable socket joints may swivel and be formed into a variety of shapes including the form where the hose may stand upright in a self-supporting position.

The nozzle portion of the hose assembly has a compression and depression capabilities. When the nozzle is released a substance like water or air moves through the nozzle and may be directed by the user to a specific location. When the nozzle is released, the substance flow stops moving out of the nozzle. When the nozzle is released and the substance stops running through nozzle, then the expansion joint apparatus expands and tightens the expandable socket joints and applies a force to the expandable socket joints and then the expandable socket joints are pulled tightly and they stiffen up allowing the hose to retain numerous shapes.

Expansion joints are engineered products inserted in a rigid piping system to achieve one or more of the following: absorb movement, improved thermal stability, relieve system strain due to thermal change, load stress, pumping surges, wear or settling, reduce mechanical noise, compensate for misalignment and eliminate electrolysis between dissimilar metals. Expansion joints attached to hoses, like piping systems are able to control flow and pressure through a hose.

Pressure balanced expansion joints are often included in industrial piping systems to accommodate movement due to thermal and mechanical changes in the system. Expansion joints with metal bellows are designed to accommodate certain movements while minimizing the transfer of forces to sensitive components in the system. Pressure created by pumps is used to move fluids through a hose assembly system. Fluids under pressure occupy the volume of the flexible hose. The unique concept of pressure-balanced expansion joints is they are designed to maintain a constant volume by having balancing bellows compensate for volume changes in the hose.

There has thus been outlined, rather broadly, the more important features of the versatile integrated self-supported fluid delivery mechanism and series of accompanying systems and apparatuses and embodiments in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and manners of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practice and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1A illustrates a 3-D view of an expandable socket joint.

FIG. 1B illustrates a cross-sectional view of an embodiment of the present system, particularly elements of the expandable socket join.

FIG. 2A illustrates a type of back-pressure protection apparatus with an expansion joint.

FIG. 2B illustrates a cross-sectional view of the expansion joint.

FIG. 3 illustrates one embodiment of the present system fully assembled in an upright, self-supporting position.

FIG. 4 illustrates an additional embodiment of the present system fully prototyped and attached to a spigot and pressured with liquid in an upright, self-supporting position.

### DETAILED DESCRIPTION OF THE SEVERAL EMBODIMENTS

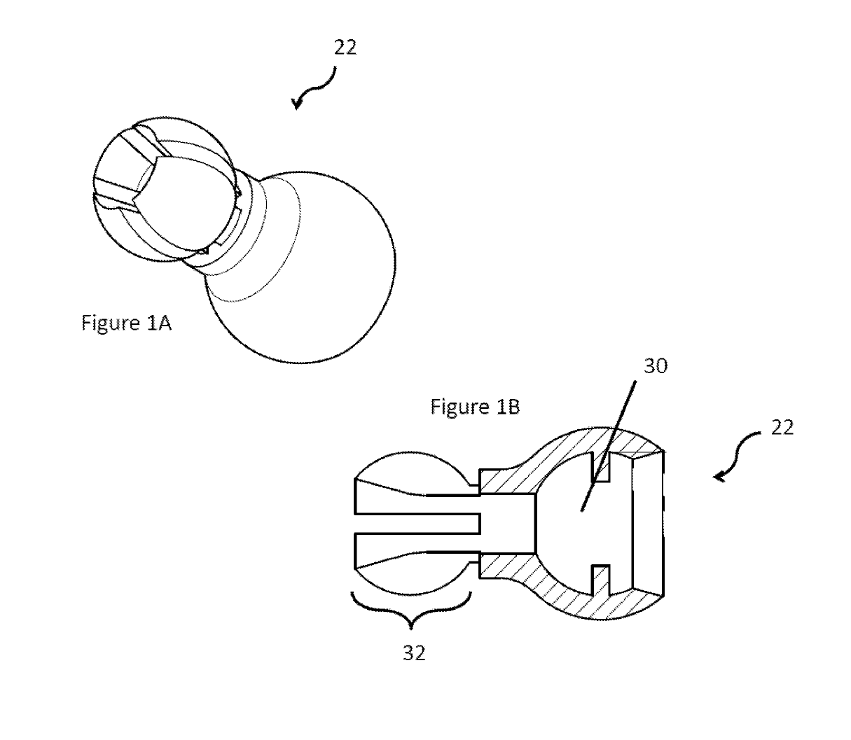

FIG. 1A illustrates a three-dimensional view of an expandable socket joint 22. A series of these expandable socket joints are attached together to form the overall hose assembly.

FIG. 1B illustrates a cross-sectional view of the elements of the expandable socket joint 22. The expandable socket joint has a ball-like mechanism 32. The ball-like mechanism is able to attach to a socket mechanism 30. When multiple expandable socket joints are attached together, they are able to form a sturdy, flexible, light-weight structure.

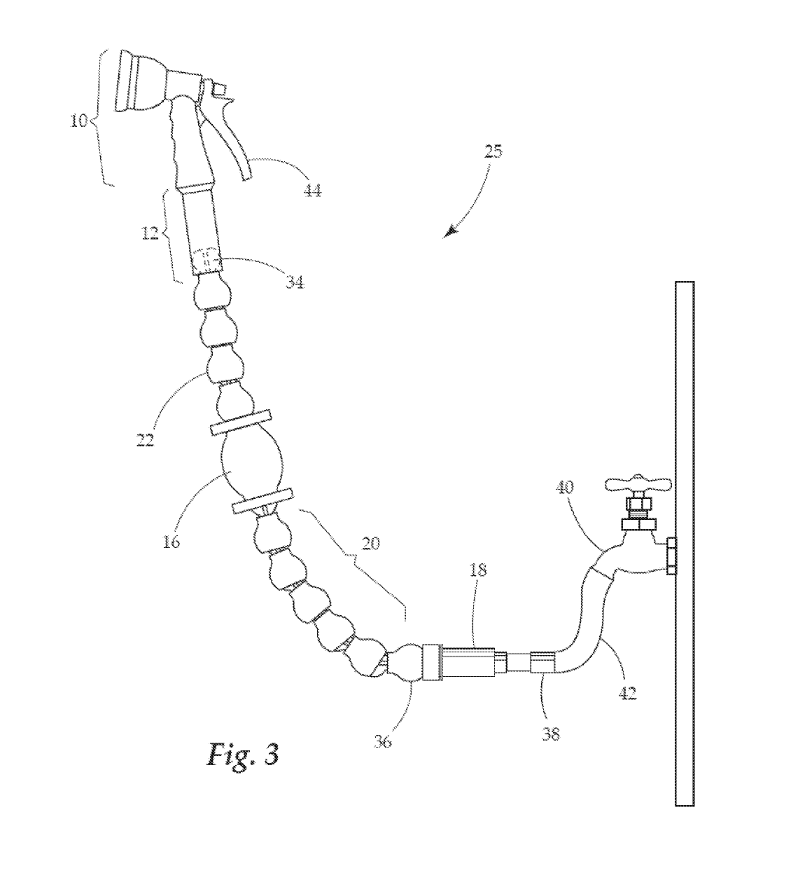

The expandable socket joints 22 may be made of Teflon® that are assembled from a proximal end (See FIG. 3, 34) to a distal end (See FIG. 3, 36). The Teflon® expandable socket joints react to pressure and force and when force is applied to the Teflon® expandable socket joints, the Teflon® expandable socket joints 22 are pulled tightly, resulting in the assembly stiffing up in whatever position the user wishes to have (See FIG. 3). The Teflon® parts may swivel like a goose neck and are moveable and may be shaped to stand on its own, as illustrated in FIG. 3. Next, the user may shape the assembly so that the hose does not collapse, relieving the user from having to bend over to pick up the hose.

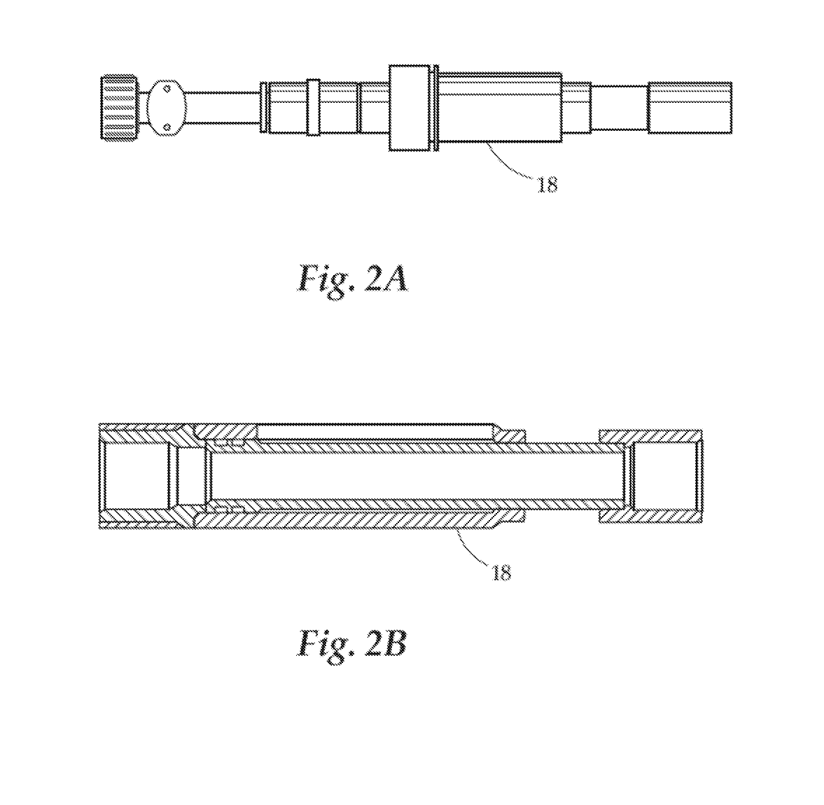

FIGS. 2A-2B illustrates a type of back-pressure protection apparatus with an expansion joint 18 and a cross-sectional view of the expansion joint 18.

FIG. 3 illustrates one embodiment of the present system incorporating the different elements of the hose assembly. The hose assembly 25 has a series of attached expandable socket joints 20 which, when fully assembled has a proximal end 34 and a distal end 36. A light weight plastic nozzle 10, in this case a plastic water nozzle, is attached to the proximal end 34 of a flexible tube 12, which is then surrounded by the expandable socket joints 22 forming a series of expandable socket joints 20. A back-pressure protection apparatus with an expansion joint 18 is attached to the distal end 36 of the flexible tube 12. The opposite end of the back-pressure protection apparatus may be attached to a pressure source, in this case a water source, where the end may have a female hose connector 38 to connect to a water source.

The back-pressure protection apparatus with an expansion joint 18 may expand and contract when pressure is on or off. Further, the overall hose assembly may also possess one or more check valves 16. When the pressure source is adjusted or turned off, the check valve allows the hose assembly to keep its shape until the user drains the substance from the hose, in this case, the user would drain the rest of the water from the hose when he has completed his task.

In the one embodiment shown in FIG. 3, an end of a flexible tube 42 may be attached to a water source 40 and when the water source is turned on the water moves through the flexible tube to the back-pressure protection apparatus, through the expandable socket joints 22, and to a plastic water nozzle 10. The plastic nozzle has a means to be released and depressed 44. When the plastic nozzle is depressed, the water moves through the nozzle from the expandable socket joints and may be directed to a determined location. In this instant embodiment, the user may direct the water to spray a car while washing the car.

When the plastic nozzle is released, the water flow stops from flowing out the nozzle. When the water flow stops, the back-pressure protection apparatus with the expansion joint expands and tightens the internal wire, which in turn then applies a force to the Teflon® expandable socket joints. Once the Teflon® expandable socket joints are pulled tightly and stiffen up, then the user can manipulate the hose to “self-stand,” without any outside support like a moveable or permanent stand.

When the pressure source is turned off and the water is released from the check valve, the hose assembly becomes unpressured allowing for easy storage and maneuverability.

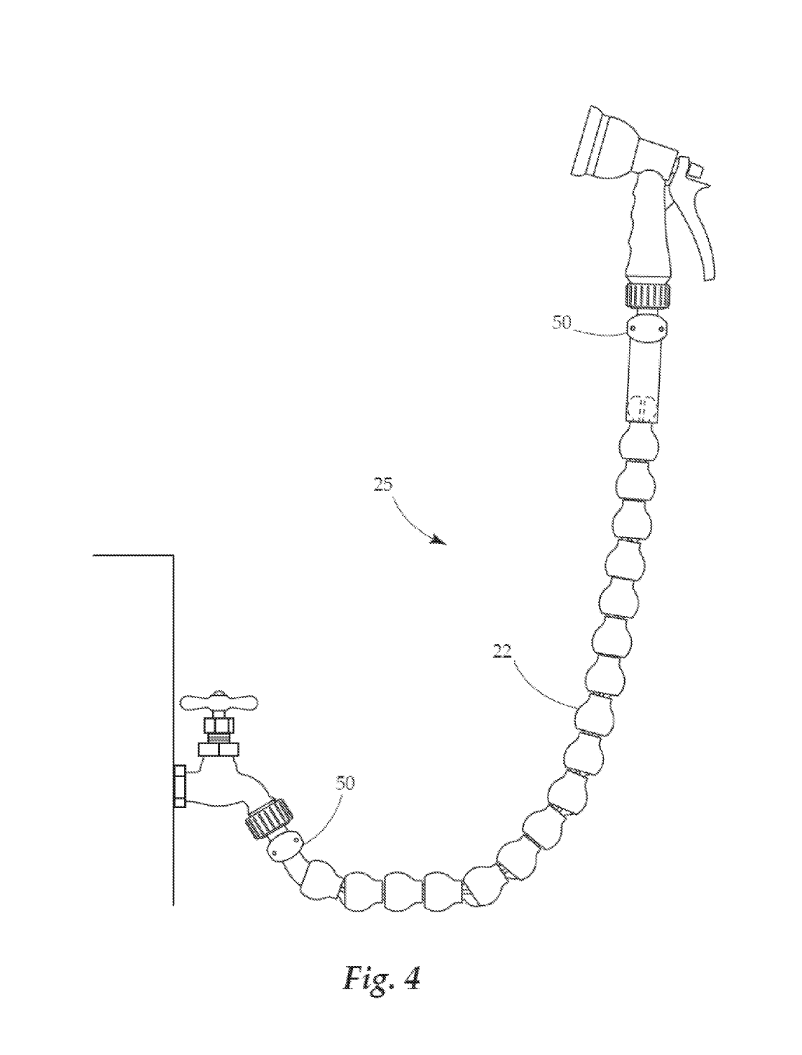

Finally, FIG. 4 illustrates an additional embodiment of the present system 25 fully prototyped and attached to a spigot and pressured with liquid in an upright, self-supporting position. In this embodiment, a hose assembly 50 is utilized and the hose assembly 50 is reeved through the expandable socket joints 22 and upon expansion of the hose assembly 50 the expandable socket joints 22 stiffen and provide the system the capability to stand on end.

What is claimed is:

1. A self-supported hose delivery assembly comprising:
a flexible tube, wherein the flexible tube further comprises:
a proximal end; and
a distal end;
a series of at least one expandable socket joints, wherein the series of at least one expandable socket joints are attached around the flexible tube from the proximal end of the flexible tube, to the distal end of the flexible tube;
a nozzle; wherein the nozzle is attached to the proximal end of the series of at least one expandable socket joints; and
a back pressure protection apparatus; wherein the back pressure protection apparatus is attached to the distal end of the series of at least one expandable socket joints.

2. The self-supported hose delivery assembly of claim 1, wherein the at least one expandable socket joints further comprises:
a ball-like mechanism; and
a socket mechanism.

3. The self-supported hose delivery assembly of claim 2, wherein the ball-like mechanism of the at least one expandable socket joint attaches to the socket mechanism of the at least one expandable socket joint.

4. The self-supported hose delivery assembly of claim 1, wherein the at least one expandable socket joints comprises of a material selected from the group consisting of stainless steel, polymer, copper, aluminum, bronze, and Teflon®.

5. The self-supported hose delivery assembly of claim 1 wherein the back pressure protection apparatus further comprises an expansion joint apparatus.

6. The self-supported hose delivery assembly of claim 5, wherein the expansion joint apparatus expands and contracts with pressure.

7. The self-supported hose delivery assembly of claim 1, wherein the back-pressure protection apparatus further comprises an end that attaches to a pressure source.

8. The self-supported hose delivery assembly of claim 7, wherein the pressure source is selected from the group consisting of fluid pressure, liquid pressure, gas pressure, air pressure, and vapor pressure.

9. The self-supported hose delivery assembly of claim 7, wherein the pressure source releases a fluid substance selected from the group consisting of water, other liquids, gas, air, and vapor.

10. The self-supported hose delivery assembly of claim 1, wherein the nozzle further comprises an actuation member.

11. The self-supported hose delivery assembly of claim 10, wherein upon depression of the actuation member, the fluid substance moves through the nozzle from the series of at least one expandable socket joints.

12. The self-supported hose delivery assembly of claim 10, wherein upon release of the actuation member, the substance ceases to flow out of the nozzle.

13. The self-supported hose delivery assembly of claim 12, wherein upon cessation of flow of the fluid substance, the expansion joint apparatus expands and tightens the series of at least one expandable socket joints.

14. The self-supported hose delivery assembly of claim 13, wherein when the force is applied to the series of at least one expandable socket joints, the at least one expandable socket joints are pulled tightly, stiffen up.

15. The self-supported hose delivery assembly of claim 1, wherein the series of at least one expandable socket joints further comprise a swivel mechanism.
